(19) United States
(12) Patent Application Publication
(10) Pub. No.: US 2005/0225658 A1
(43) Pub. Date: Oct. 13, 2005

(54) Digital camera

(76) Inventor: Tatsuhiko Ikehata, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/876,607

(22) Filed: Jun. 28, 2004

(30) Foreign Application Priority Data
Jun. 30, 2003 (JP) 2003-188706

(51) Int. Cl. H04N 5/222

(52) U.S. Cl. 348/333.01

(57) ABSTRACT

A digital camera comprising a camera body, a display unit, and a control unit. The display unit can display a plurality of optical patterns. The control unit controls the display unit, causing the display unit to display one of the optical patterns in accordance with a mode in which the digital camera is operating.

### CROSS-REFERENCE TO RELATED APPLICATIONS

This application is based upon and claims the benefit of priority from prior Japanese Patent Application No. 2003-188706, filed Jun. 30, 2003, the entire contents of which are incorporated herein by reference.

### BACKGROUND OF THE INVENTION

1. Field of the Invention

The present invention relates to a digital camera that has a display unit.

2. Description of the Related Art

Most digital cameras have a camera body, a lens exposed outside the camera body, an electronic viewfinder, and various switches. The lens is provided on the front of the camera body. As Jpn. UT Appln. KOKAI Publication No. 5-68179 discloses, an digital camera may have a tally lamp on the camera body.

The tally lamp has light-emitting diodes (LEDs). It blinks while the camera is operating to take pictures. When the self-timer is used to take a picture, the tally lamp operates, informing the user of the operating state of the self-timer.

The tally lamp has a red-light-emitting diode and a green-light-emitting diode. Thus, the tally lamp can emit red light and green light. Each light-emitting diode may emit no light, emits light in blinking mode to indicate, but only a few operating mode of the camera. In other words, the tally lamp can give the camera user, but a small amount of information about the operation of the camera.

### BRIEF SUMMARY OF THE INVENTION

According to an aspect of this invention, there is provided a digital camera that comprises a camera body, a display unit, and a control unit. The display unit can display a plurality of optical patterns. The control unit controls the display unit, causing the display unit to display one of the optical patterns in accordance with a mode in which the digital camera is operating.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a flowchart explaining how front LEDs is controlled to emit light in different modes;

FIG. 2 is a perspective view of a digital camera according to the invention, as viewed from the front;

FIG. 3 is a plan view of the mode dial that is provided on the camera body of the digital camera shown in FIG. 2;

FIG. 4 is a perspective view of the digital camera shown in FIG. 2, as viewed from the back of the camera and somewhat below;

FIG. 5 is a block diagram showing the optical section and electric section of the digital camera shown in FIG. 2 and 4;

FIG. 6 is a flowchart explaining how the front LED emits light in a mode different from the light-emitting mode described with reference to FIG. 1;

FIG. 7 is a diagram explaining how various light-emitting modes of the front LED are set in association with the modes in which the digital camera can operate; and

FIG. 8 is a block diagram illustrating how the customizing unit (FIG. 5) operates to customize various light-emitting modes of the front LED.

### DETAILED DESCRIPTION OF THE INVENTION

A digital camera that is an embodiment of this invention will be described below, with reference to the accompanying drawings.

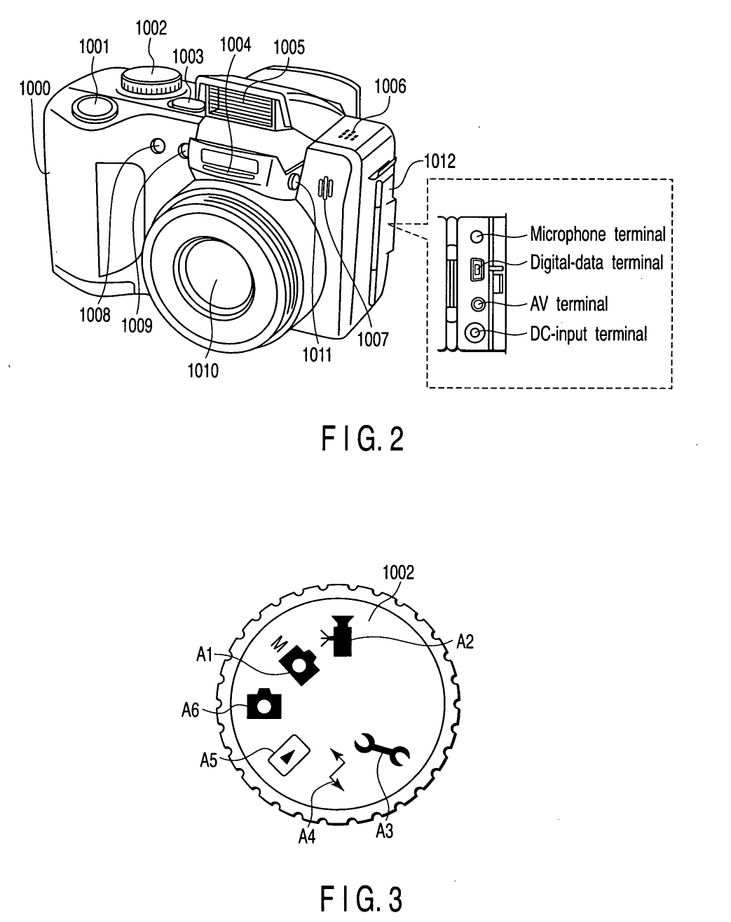

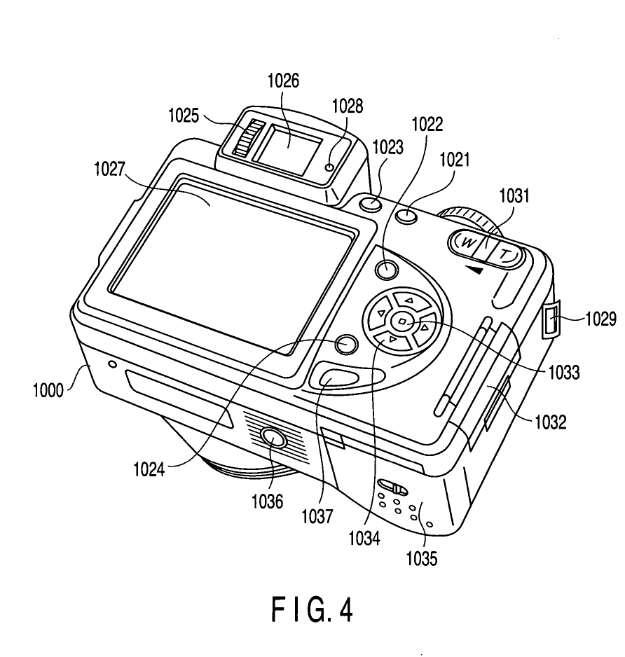

FIG. 2 is a perspective view of the digital camera according to the invention, as seen from the front. FIG. 4 is another perspective view of the digital camera seen from the back and somewhat below.

As FIG. 2 shows, the digital camera has a shutter button 1001, a mode dial 1002, a power switch 1003, and a front LED 1004 serving as display unit, all provided on the camera body 1000. The display unit is called “front LED” that displays the mode in which the digital camera is operating. The front LED 1004 characterizes the digital camera. The front LED 1004 has a plurality of light-emitting diodes.

The digital camera has a flash lamp 1005, a speaker 1006, a microphone 1007, a remote-control light-receiving unit 1008, a flashlight sensor 1009, and a lens 1010. The remote-control light-receiving unit 1008 is provided to receive optical signals emitted from a remote controller (not shown).

The digital camera has a flash-open button 1011 and a terminal cover 1012, too. The terminal cover 1012 may be opened to expose an external-microphone terminal, a digital-data terminal, an AV terminal and a DC-input terminal. It should be noted that the front LED 1004 and the lens 1010 are provided on the front of the camera body and oriented in the same direction (that is, oriented forwards).

FIG. 3 is a plan view of the mode dial 1002. The mode dial 1002 has icons A1 to A6 printed on it. The icons represent various modes in which the camera can operate. Icon A1 represents the manual-photographing mode (in which the white balance, exposure time, diaphragm opening, shutter speed, and the like can be manually controlled). Icon A2 represents the moving-picture mode (in which a moving picture can be photographed). Icon A3 represents the setup mode (in which the basic setups of the camera, e.g., sound, automatic power-off, customizing, language, video-data output, date and system mode).

Icon A4 represents the PC mode (in which video data is input to personal computers). Icon A5 represents the reproduction mode, and icon A6 represents the automatic photographing mode. The user may turn the mode dial 1002 to bring one of icons A1 to A6 to a specified position, thereby to select the operating mode that the icon represents.

As FIG. 4 shows, a flash button 1021, a menu button 1022, a self-timer & remote-control button 1023, an erase button 1024, and a visibility-adjusting dial 1025 are arranged on the back of the camera. An electronic viewfinder 1026 and a liquid crystal display unit 1027 are provided on the back of the camera, too. The liquid crystal display unit 1027 has a screen larger than that of the electronic viewfinder 1026, which is a liquid crystal display, too. The liquid crystal display unit 1027 will be called “LCD screen” so that it may be distinguished from the electronic viewfinder (EVF).

A finder LED 1028 is arranged besides the EVF 1026; it may emit light to show that the EVF 1026 is on. A shoulder-strap holder 1029 is secured to one side of the camera. Moreover, a Tele/Wide button 1031, an OK button 1033 and selection buttons 1034 are provided on the back of the camera. When operated, the Tele/Wide button 1031 set a degree of zooming. When pushed, each selection button 1034 selects a menu items or an image. A card cover 1032 is provided to one side of the camera. A battery cover 1035 is provided on the bottom of the camera. A screw hole 1036 is cut in the bottom of the camera, to hold the top of a tripod.

A display button 1037 is arranged on the back of the camera. When depressed, the display button 1037 switches the display mode of the EVF 1026 and the LCD screen 1027. If pushed rather long, the display button 1037 sets the EVF 1026 and the LCD screen 1027 in sleep mode to save the battery power. The LCD screen 1027 has a size ranging from 1.5 to 2.5 inches, as most display units of this type. By contrast, the EVF 1026 is a small peeping window.

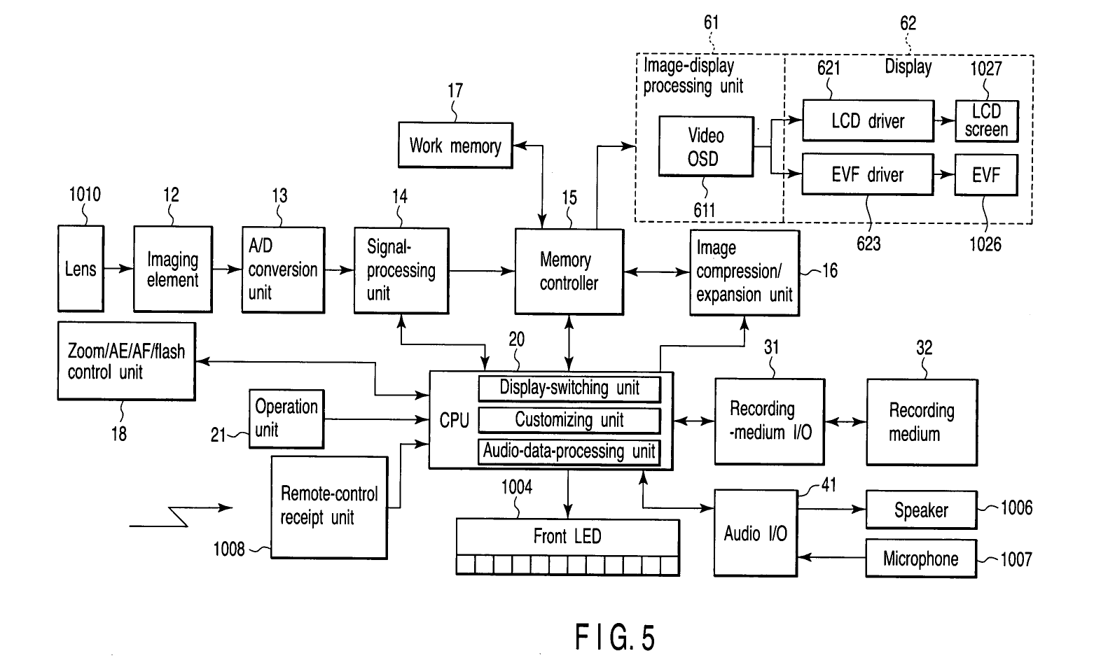

FIG. 5 is a block diagram that illustrates the optical section and electric section of the digital camera. As may be understood from FIG. 5, the light from a subject for photography passes through a lens 1010 and reaches the image-forming surface of an imaging element 12 (e.g., a CCD element), thus forming an image of the subject. The imaging element 12 converts the image into an electric signal. The electric signal is supplied to an analog-to-digital (A/D) conversion unit 13. The unit 13 converts the signal to a digital signal, which is input to a signal-processing unit 14. The signal-processing unit 14 performs gamma correction, color-signal separation, white-balance control, and the like.

Unless the shutter is operated in normal photographing conditions, the signal-processing unit 14 outputs video data via a memory controller 15 to an image-display processing unit 61. The processing unit 61 converts the video data to data that the EVF 1026 or LCD screen 1027 can display and combines menu items or the like data items, thus generating new video data. This video data is supplied from the image-display processing unit 61 to the LCD driver 621 and/or the EVF driver 623, both incorporated in a display 62. Thus, the EVF 1026 or the LCD screen 1027 displays the image being photographed.

When the shutter is operated, an image compression/expansion unit 16 compresses the video data (in JPEG mode, for example). The video data thus compressed is stored via a recording-medium interface 31 into a recording medium 32 under the control of a CPU (Central Processing Unit) 20. The recording medium 32 may be one selected from various media. It may be, for example, a semiconductor memory, an optical disk or a magnetic disk.

The video data may be read from the recording medium 32. In this case, the image compression/expansion unit 16 expands the video data under the control of the CPU 20. The video data thus expanded is input to the image-display processing unit 61 the memory controller 15. Thus, the EVF 1026 or the LCD screen 1027 displays the image represented by the video data.

A work memory 17 is used in the process of editing the video data, forming a thumbnail image or changing the order of images. The work memory 17 can store one frame of video data or frames of video data. The video data stored in the work memory 17 is input, whenever necessary, to the image-display processing unit 61 via the memory controller 15. Thus, the user can know how the video data is being edited, looking at the image displayed by the display 62.

While the video data is being generated or edited, audio data can be acquired from a microphone 1007 via an audio interface 41 under the control of the CPU 20. The audio data is stored, along with the video data, in the recording medium 32. The audio data is read from the recording medium 32, together with the video data. It is then supplied via the audio interface 41 to a speaker 1006. The speaker 1006 generates sound from the audio data, while the video data is being reproduced.

In preparation for a photographing operation, the CPU 20 makes a control unit 18 perform zooming, AE (Auto Exposure) adjustment, AF (Auto Focus) adjustment, flash control and the like in accordance with control signals. The CPU 20 receives operation signals from external devices through an operation unit 21 and a remote-control receipt unit 1008. The CPU 20 is connected to an external connection interface (not shown). Hence, the camera can be connected to external displays such as TVs.

The CPU 20 can control the front LED 1004. The front LED 1004 can emit light in different colors, each in various modes, to inform the user of the current operating mode of the camera. More precisely, the front LED 51 can emit light in, for example, seven colors. It can emit light in each color in, for example, four modes, i.e., slow blinking, rapid blinking, continuous light-emission and intermittent light-emission.

The user can combine each light-emitting mode with the colors in which the front LED 1004 can emit light. In other words, the user can customize various mode-color combinations. This customization is another characterizing feature of the present embodiment and will be later described in detail.

The digital camera has two display units (i.e., first display unit (EVF) and second display unit (LCD screen)). These displays are automatically switched, from one to the other, in accordance with the mode in which the digital camera is operating.

The CPU 20 has a customizing unit, an audio-data-processing unit, and a display-switching unit. The customizing unit customizes various mode-color combinations. The audio-data-processing unit processes audio data. The display-switching unit switches the two display units. The CPU further has a means for changing the operating mode of each display unit to the previous operating mode. The previous operating mode is, for example, the initial operating mode that is set when the power switch is turned off. The CPU has a detecting means for detecting the mode in which the digital camera is operating.

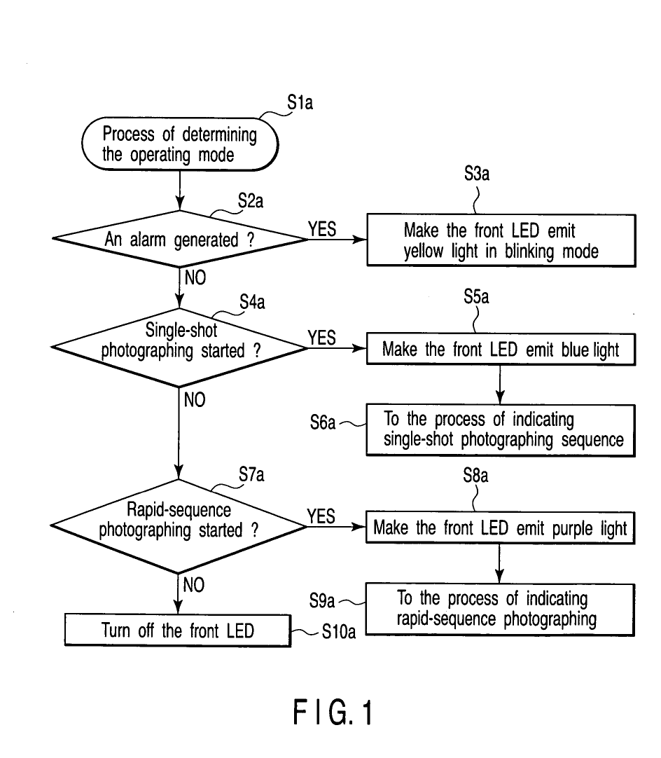

FIG. 1 is a flowchart explaining how the CPU 20 controls the front LED 1004, causing the front LED 1004 to emit light in various modes in accordance with the operating mode of the digital camera.

When the user operates the camera in a specific mode (for example, focus control or exposure control), the CPU 20 performs the process of determining the operating mode (Step S1a). First, it is determined whether an alarm has been generated during, for example, the focus control (Step S2a). If YES, the front LED emits yellow light in blinking mode (Step S3a). The alarm is generated when a malfunction, e.g., focusing failure, develops in the digital camera.

If no alarm has been generated or if an alarm ceases, it is determined whether single-shot photographing has started (Step S4a). (For example, it is determined whether the shutter button 1001 has been pushed.) If YES, the front LED 1004 emits blue light (Step S5a). Then, the operation goes to the process of indicating single-shot photographing sequence (Step S6a). Seeing the front LED 1004 emitting blue light, both the user and the subject for photography know that the digital camera is performing the single-shot photographing.

If NO in Step S4a, or if the single-shot photographing has not started, the operation goes to Step S7a. In Step S7a, it is determined whether rapid-sequence photographing has started. If YES, the front LED 1004 emits purple light (Step S8a). Then, the operation goes to the process of indicating rapid-sequence photographing (step S9a). Seeing the front LCD keeps emitting purple light, both the user and the subject for photography know that the digital camera is performing the rapid-sequence photographing. If NO in Step S7a, or if it is determined that the rapid-sequence photographing has not started, the operation goes to Step S10a. In Step S10a, the front LED 1004 is turned off.

How the CPU 20 controls the front LED 1004 during the rapid-sequence photographing will be described. More precisely, the front LED 1004 In Step S8a emits light in a different color every time the camera takes a picture. Thus, the subject for photography can know which picture is taken at what timing. This is helpful particularly when self-timer photographing is performed or when the digital camera is remote-controlled, as will be explained below.

An alarm is generated when the power remaining in the battery, i.e., the power-supply unit, becomes insufficient, or when the vacant storage area of the recording medium 32 decreases too much. When an alarm is generated, the CPU 20 causes the front LED 1004 to emit yellow light in blinking mode. Seeing the front LED 1004 emitting yellow light intermittently, the user perceives the alarm.

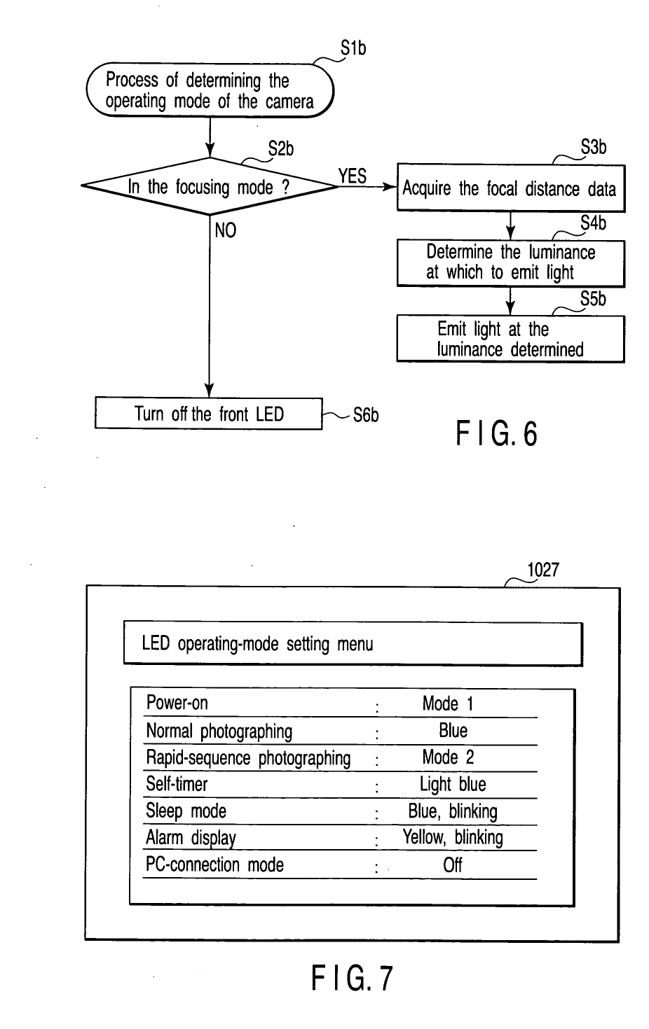

FIG. 6 is a flowchart explaining how the front LED emits light in a specific mode while the digital camera is performing the focusing operation. First, the CPU 20 determines the mode in which the digital camera is operating (Step S1b). Then, the CPU determines whether the camera is performing the focusing operation (Step S2b). If YES, the CPU 20 acquires focal distance data (Step S3b).

In accordance with the focal distance data, the CPU 20 determines the luminance at which the front LED 1004 should emit light (Step S4b). Thus, the front LED 1004 emits light at the luminance thus determined (Step S5b). The longer the focal distance, the higher is the luminance of the light the front LED 1004 emits. Perceiving the luminance of the light the front LED 1004 emits, both the user and the subject for photography know that the digital camera is performing the focusing operation. If NO in Step S2b, or if the camera is not performing the focusing operation, the front LED 1004 is turned off (Step S6b).

How the CPU 20 customizes the various light-emitting modes of the front LED will be described.

To enable the user to customize the light-emitting modes of the front LED 1004, the LCD screen 1027 displays an LED operating-mode setting menu, as is illustrated in FIG. 7. The menu shows seven operating modes of the digital camera. Thus, the user can customize seven light-emitting modes for the front LED 1004 in association with the operating modes of the camera, respectively. For example, the user can set light-emitting mode 1 as shown in FIG. 7. In this case, the front LED 1004 emits light in mode 1 when the power switch 1003 is turned on to activate the digital camera.

The customizing unit incorporated in the CPU 20 stores information representing a plurality of light-emitting modes, each differs in color and luminance of the light the front LED 1004 emits. When the power switch 1003 is turned on, the front LED 1004 emits light in, for example, the light-emitting mode 1 set in the customizing unit. The front LED 1004 emits light in other light-emitting modes set in the customizing unit while the digital camera remains in various operating modes such as the single-shot photographing mode, rapid-sequence photographing mode, self-timer photographing and sleep mode, respectively. When an alarm is generated, the front LED 1004 emits light in a specific mode. As long as the digital camera is connected to a PC (Personal Computer), the front LED 1004 emits light a particular mode.

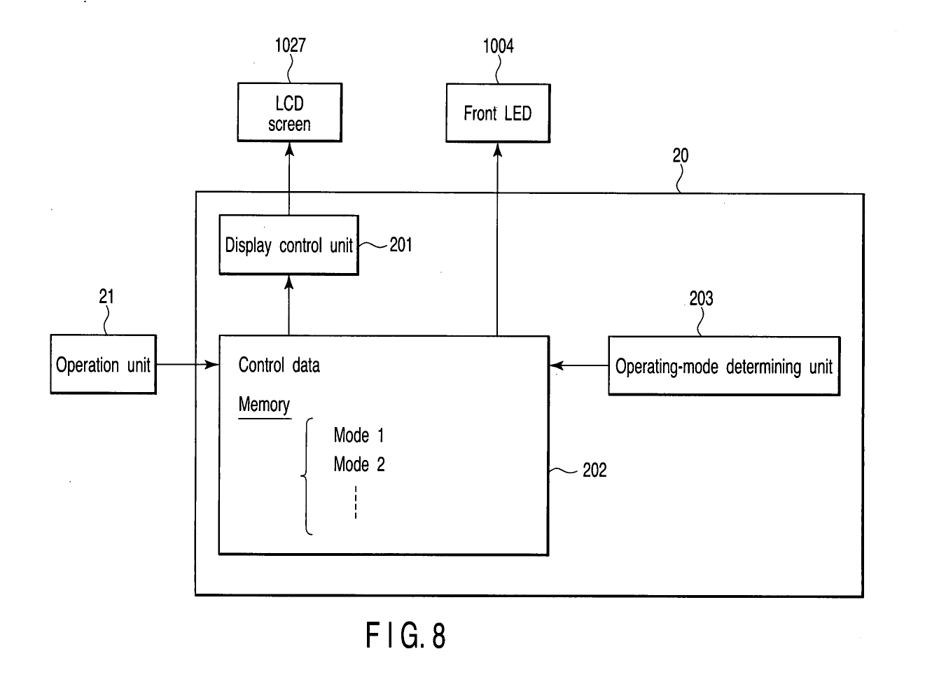

It will be described how the customizing unit customizes the light-emitting modes will be described, with reference to FIG. 8. As FIG. 8 shows, the customizing unit includes a display control unit 201, control data 202 and operating-mode determining unit 203.

The user may operate the operation unit 21, selecting some light-emitting modes for some operating modes of the camera, respectively. In this case, the data items representing the light-emitting modes selected are read from the control data 202. These data items are transmitted via the display control unit 201 to the LCD screen 1027. The LCD screen 1027 displays the light-emitting modes in association with the corresponding operating modes of the digital camera.

To customize any desired light-emitting modes, the user operates the operation unit 21, selecting these light-emitting modes. Once so selected, the desired light-emitting mode is displayed on the LCD screen 1027, besides the corresponding operating mode of the camera. Hence, the user can confirm that the light-emitting mode has been associated with the operating mode of the camera. Then, the data item representing the light-emitting mode thus set in association with a specific operating mode of the camera is stored into the control data 202. Thus, the light-emitting mode is customized.

How the front LED 1004 emits light in the modes thus customized will be explained. First, the operating-mode determining unit 203 determines in which mode the digital camera is operating. Then, the front LED 1004 emits light in the mode that is associated with the operating mode the unit 203 has determined.

When the digital camera so configured as described above is operated, the front LED emits light a specific mode. For example, it emits light in a mode when the shutter button 1001 is pushed, and in another mode when a process of photographing a subject is completed. Therefore, the user of the camera, as well as the subject for photography, can know in which mode the digital camera is operating. While the digital camera is operating in the rapid-sequence photographing mode, the light-emitting mode of the front LED 1004 changes every time the camera takes a picture. Thus, the subject can know when he or she is photographed. He or she may not move until the light-emitting mode changes from one to another. This helps to prevent unsuccessful photographing, particularly when the camera operates in self-timer mode or remote-control mode.

During the remote-controlled photographing, the power remaining the battery may become insufficient, or the vacant storage area of the recording medium 32 may decrease too much. In either case, the front LED 1004 intermittently emits yellow light. Seeing the front LED 1004 emitting yellow light in blinking mode, the user can know that the battery is running out or the medium 32 is almost full of data.

Moreover, the luminance at which the front LED 1004 emits light changes in accordance the focal distance. More correctly, the longer the focal distance, the higher is the luminance of the light the front LED 1004 emits. The user of the camera, as well as the subject for photography, can learn that the focusing is erroneous if he or she perceives that the luminance is too high or low. This helps to prevent unsuccessful photographing.

The CPU 20 enables the user to customize various light-emitting modes for the front LED 1004 in whichever way he or she likes. That is, the user can change the preset light-emitting modes shown in the LED operating-mode setting menu that is displayed on the LCD screen 1027 when the power switch 1003 is turned on. This may be convenient, particularly to those who are color-blind.

As has been described, the front LED 1004 can emit light in various modes to inform the subject for photography in which mode the digital camera is operating. This helps to prevent unsuccessful photographing. The front LED 1004 can give useful information, particularly when the camera operates in self-timer mode or the subject for photography operates a remote controller to control the camera.

The present invention is not limited to the embodiment described above. Various changes and modifications can be made within the scope and spirit of the invention. For example, the light-emitting modes of the front LED 1004 are not limited to those specified above. The front LED 1004 may emit light in any other modes. The invention is not limited to digital cameras. Rather, it may be applied to photographing apparatuses of any other types that have a display unit equivalent to the front LCD 1004. Further, the front LCD 1004, which has a plurality of light-emitting diodes, may be replaced by any other display device that can emit light in such various modes as specified above.

1. A digital camera, comprising:
a camera body;
a display unit which is configured to display a plurality of optical patterns; and
a control unit which controls the display unit, causing the display unit to display one of the optical patterns in accordance with a mode in which the digital camera is operating.

2. The digital camera according to claim 1, wherein the optical patterns are different in color.

3. The digital camera according to claim 1, wherein the optical patterns are different in luminance.

4. The digital camera according to claim 1, wherein the optical patterns are different in color and luminance.

5. The digital camera according to claim 1, wherein the control unit is provided in the camera body and the display unit is provided on the camera body and has a plurality of light-emitting diodes which are provided on a front of the camera body.

6. The digital camera according to claim 5, which further comprises a lens provided on the camera body, and in which the lens and the display unit are oriented in the same direction.

7. The digital camera according to claim 1, wherein the display unit displays an optical pattern while the digital camera is operating in a single-shot photographing mode, and other optical patterns while the digital camera is operating in a rapid-sequence photographing mode.

8. The digital camera according to claim 7, wherein the optical pattern which the display unit displays changes every time a picture is taken in the rapid-sequence photographing mode.

9. The digital camera according to claim 1, wherein the control unit has a power-supply unit, and the display unit displays a specific optical pattern in accordance with power remaining in the power-supply unit.

10. The digital camera according to claim 1, which further comprises a recording medium configured to supply and receive data to and from the control unit, and in which the display unit displays a specific optical pattern in accordance with a vacant storage area of the recording medium.

11. The digital camera according to claim 1, wherein the display unit emits light at luminance that is proportional to a focal distance.

12. The digital camera according to claim 1, further comprising means for enabling a user to customize the optical patterns.
